(19) United States
(12) Patent Application Publication
(10) Pub. No.: US 2002/0008103 A1
(43) Pub. Date: Jan. 24, 2002

(54) Microwave device

(76) Inventor: Leif Gosta Zettergren, Jarfalla (SE)

Correspondence Address: PENNIE AND EDMONDS, 1155 AVENUE OF THE AMERICAS, NEW YORK, NY, 100362711

(21) Appl. No.: 09/960,057

(22) Filed: Sep. 21, 2001

Related U.S. Application Data
(63) Continuation of application No. PCT/SE00/00575, filed on Mar. 22, 2000.

(51) Int. Cl. H05B 6/80

(52) U.S. Cl. 219/761; 219/757

(57) ABSTRACT

Microwave unit for drying or similar treatment of objects not enclosed in a microwave oven. An air-cooled magnetron 4 enclosed in a magnetron box is used as microwave generator. The cooling air is governed so as to obtain a forced air stream over the colling surfaces. The unit allows higher power output with respect to high frequency energy without a corresponding increase of input power. Method for ameliorating cooling.

Microwave devices are used, inter alia, for converting electrical energy to heat. The use is limited to substances with dielectric molecules. Most common among such substances is water. The conversion to heat occurs within the material. Thus, one is spared diffusion processes, which may be very slow in materials with isolating properties. One example of small scale use of microwave technique is microwave ovens for domestic use. Similar units, with one open side, have been used for some time for drying, sanifying or other similar treatments of building details with very satisfying results. See for instance PCT/SE95/00219, WO95/239451.

Swedish patent No. 9004018-9 (467 709) refers to an arrangement for simultaneous treatment of objects with heated air and microwave energy. The only more important difference in relation to conventional microwave units is that the blowing fan, proposed to be common for several microwave units, may be over-dimensioned to carry away water vapor, which is produced at the use of the units. No arrangement is proposed for making the cooling of the microwave generation more efficient. Instead the equipment design according to the drawings is such so that the cooling air passes the cooling flanges of the magnetrons at right angles. As shown below, this gives low cooling effect due to stagnant air cushions between the flanges.

Beside a magnetron microwave unit usually comprises a power package consisting of a transformer and a resonance circuit coupled to the transformer. Other electronic details for the control of the unit may occur too. The magnetron and other electronic equipment are usually placed together in an upper part of the unit. Usually this upper part is divided from the lower part by a perforated plate or a grille, which allows air passage, but prevents passage of microwaves. The magnetron is mounted on the perforaated plate so that the microwave radiation occurs below the plate. Thus, the upper chamber is kept essentially free from microwaves.

In the upper chamber the temperature must not rise to more than 80° C. at most. The magnetron and transformer and other electronic equipment generate heat and must be cooled not to be destroyed by the generated heat. For large magnetrons water cooling is often used. For smaller and cheaper magnetrons, used for domestic ovens etc., air cooling is used. A standard design for such magnetrons is a parallellepipedic box with a solid upper side, a solid underside with a projecting transmitting antenna, which radiates microwaves, two opposite, solid sides and two opposite, open sides to allow entrance of cooling air. Usually one is satisfied by blowing in cooling air in the chamber where the electronic equipment is situated and let convection control the cooling air distribution. No special measures for controlling air flow are common. The air passes the perforated plate and is let out through the gap between the lower border of the plate box and the upper surface of the treated object. In this way the cooling air fulfils a double function, i.e. it serves both to dispose of heat excess from the electronic equipment and to dispose of the water vapour released from the object at microwave treatment.

From practical reasons, when microwave units of mentioned air cooled type are used in small scale equipment for drying or similar, placing the intake for cooling air at the upper side is usually appropriate. At drying and similar operations it is desirable that the magnetron can sustain lengthy loading at maximal power. This puts special emphasis on efficient cooling. In a domestic oven the conversion efficiency, which is often low for this type of devices, does not mean very much from the economical point of view. In contrast hereto, for mentioned use for drying and similar the conversion efficiency is essential not just directly economically, but also because available power is usually limited. Therefore, a low conversion efficiency means that the time for achieving a desired treatment result has to be increased.

According to the present invention the cooling efficiency is substantially increased by active control of the flow pattern of the cooling air. This arrangement makes it possible to increase the output of microwave power without increasing the input of electric power. Means of assistance at this increase of the output power may be an ameliorated power package and a control system for the magnetron.

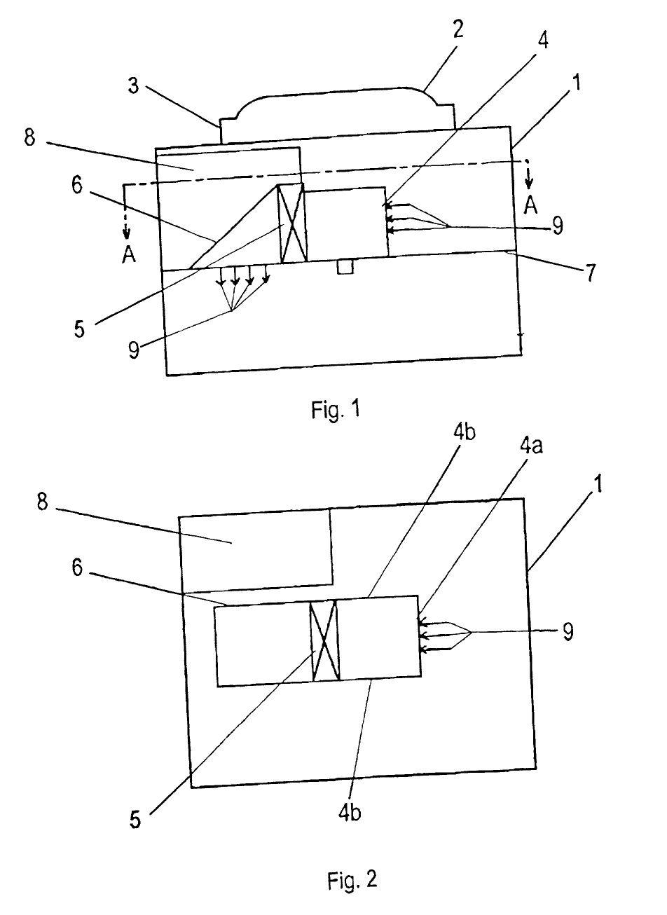

In the FIGS. 1 and 2 a preferred embodiment of the invention is shown. In the figures all details have been deleted that do not directly influence the cooling.

FIG. 1 shows a side view with removed front of a unit according to an especially preferred embodiment of the invention.

FIG. 2 shows a horizontal cross section through the line A—A in FIG. 1.

In the FIGS. 1 stands for the downwards open apparatus case, 2 for a filter provided air intake, 3 for a primary blower for blowing in cooling air in the electronic department, 4 for a magnetron box with open sides 4a and solid sides 4b, 5 stands for a secondary blower for the control of the air flow through the magnetron box, 6 is an airlock with solid sides except downwards, 7 stands for a perforated plate, which allows air passage but prevents leakage of microwaves, 8 stands for an ameliorated power package, 9 stands for arrows showing the flow direction of the cooling air. A unit according to common technique may have the same design with the exception that the power package 8, the blower 5 and the airlock 6 are missing.

At addition of cooling air from above it is at conventional design of the microwave unit large risk for getting a stagnant air zone in whole or parts of the magnetron box. This refers especially to the space between the cooling flanges. Air is a very good insulator and therefore, heat transport must happen mainly by convection, which is hindered in the narrow spaces. The stagnant air impairs the cooling and limits the power that can be taken out continuously from the unit. As electrical installations, fuses etc. must be adjusted to the maximum power the limitation means that available power cannot be used in an optimal way.

According to the invention the effect of the mentioned limitation is reduced substantially by that the air cooling is improved by means of a cross flow through the magnetron box 4. In this way one gets a directional air flow even in the narrow clefts between the flanges. In contrast to conventional designs inclusive the one of mentioned SE9004018-9, where one can use just the outer parts of the flanges for cooling, this new design achieves that the main part of the surface of the flanges assumes an active role in the cooling.

A preferred way to achieve cross flow is by means of a side mounted secondary blower 5, which aspires or blows air through the box 4. Flow technology calculations and practical tests show that the placement of the blower 5 and the flow direction 9, which is shown in the figures, i.e. to let the blower aspire air through the box gives best results. A movement of the blower 5 to the other side of the magnetron 4 with the same flow direction 9, i.e. that the blower blows air through the magnetron box gives almost as good effect. The worst result is obtained with the same blower placement and reversed flow direction, but even this unfavorable result shows better cooling than the usual, passive cooling.

The method for ameliorated cooling has been described above with a start from the use of a secondary blower 5, which treats a partial flow of the cooling air that the primary blower 3 blows in. This is a preferred method, as it requires very small modifications in the design of the microwave unit. However, obviously for a man of the art corresponding results may be achieved by means of, for instance, a suitably designed channel system for the cooling air or guiding plates leading air directly from the cooling air intake 2 and the blower 3 to the magnetron box 4. Such other designs are of course part of the invention. However, it should be observed that the increased air velocity that a secondary blower may give is very advantageous with respect to the cooling.

To use of the advantages of the new method of cooling better, the magnetron should be equipped with a more advanced control device than the conventional one. Therefore, in an especially preferred embodiment the filament current is controlled with respect to the emission state of the cathode instead of with respect to the power level of the magnetron. The latter are the conventional method. The emission state may be detected by, for instance, detecting of dynamite impedance or random noise, a light sensor, measuring the temperature of the magnetron or measuring the anode current. Examples of different methods are given in SE9603291-7, JP 5-67492, EP 449275 and DE 4238199.

Magnetrons for technical purposes are usually fed by a ferroresonant power package. Such a package includes a transformer with a comparatively large distributed inductance. With one or two capacitors the distributed inductance creates a series resonant circuit, which is tuned to the net frequency, 50 or 60 Hz. Unloaded the circuit has a high Q-value and gives after rectification a voltage to the magnetron, which during a large part of the period is the same level as its working voltage. The current fed to the magnetron will, dependant on the design of the power package, pulsate with 50 or 100 respectively with 60 or 120 Hz. Therefore, during a substantial time the current will be almost zero. The high frequency power from the magnetron will be modulated in the same way. The oscillation of the magnetron will be restarted for each pulse and one gets strong side bands to the work frequency.

This invention refers to units of a type that must often work under very difficult loading conditions. The conventional method for power feeding gives under these conditions instability with respect to the high frequency power. It is important that the power feeding remains stabile under all conditions and that the mentioned instability is eliminated. It is also important that the units do not disturb other electric equipment through feedback coupling to the electric system more than absolutely unavoidably. Therefor, in an especially preferred embodiment of the invention a new power package is used where the conversion from common alternating voltage to high voltage unidirectional current is done in several steps. Such a power package is the object of Swedish patent application No. 9603292-5 and PCT/SE97/01520.

The method of the mentioned invention comprises the stages a) conversion of alternating current to unidirectional current; b) conversion of the unidirectional current to high frequency alternating current; c) transforming of the high frequency alternating current to a high voltage alternating current with high frequency; and d) rectification of the high voltage alternating current to high voltage unidirectional current for feeding the magnetron. Power regulation is done in the stage a) with respect to the power fed in stage b). A power package designed according to the mentioned invention gives an almost constant unidirectional current.

We claim:

1. A method for air cooling of a magnetron 4, which produces microwaves and uses input power within the range 1 to 4 kW and is intended for drying or other similar treatment of objects not enclosed in a microwave oven characterised in that the air flow by means of a secondary blower 5 or other similar arrangements is governed so that a forced flow over the cooling surfaces 4 of the magnetron is obtained, and stagnant air cushions between the cooling flanges eliminated.

2. The method of claim 1 characterised in that the governing is done by means of a secondary blower 5 placed near the magnetron box 4.

3. The method of claim I and 2 characterised in that the cooling air of the magnetron 4 is governed downwards by means of an airlock 6 through a perforated floor 7.

4. A microwave unit with input power in the range 1 to 4 kW, intended for drying or other similar treatment of objects that cannot be enclosed inside a microwave oven, comprising an air cooled magnetron and required electronic equipment for controlling the unit characterised in that it is provided with equipment such as a secondary blower 5, a channel system or governing plates, for governing the air flow from the primary blower 3 to obtain a forced air stream over the cooling surfaces of the magnetron 4.

5. The microwave unit of claim 4 characterised in that it is provided with a power package 8, the working principle of which comprises the stages a) conversion of alternating current to unidirectional current; b) conversion of the unidirectional current to high frequency alternating current; c) transforming of the high frequency alternating current to a high voltage alternating current with high frequency; and d) rectifying of the high voltage alternating current to high voltage unidirectional current for feeding the magnetron, at which power regulation is done in the stage a) with regard to the power fed in stage b).

6. The microwave unit of claim 4 and 5 characterised in that it is provided with a regulation system for the filament current governed by the emission status of the cathode.
